(19) United States
(12) Patent Application Publication
(10) Pub. No.: US 2004/0082310 A1
(43) Pub. Date: Apr. 29, 2004

(54) Method of controlling a switch device using a mobile terminal in a wireless communications network

(76) Inventors: Wen-Fu Huang, Kaohsiung City (TW); Su-Yeh Ho, Ta-Li City (TW)

Correspondence Address: TROP PRUNER & HU, PC, 8554 KATY FREEWAY, SUITE 100, HOUSTON, TX, 77024, US

(21) Appl. No.: 10/395,479

(22) Filed: Mar. 24, 2003

(30) Foreign Application Priority Data
Oct. 25, 2002 (TW) 091125148

(51) Int. Cl. H04M 9/00

(52) U.S. Cl. 455/401; 455/411; 455/418

(57) ABSTRACT

To control a switch device using a mobile terminal, the owner of the mobile terminal stores caller identification data that includes call numbers associated with an authorized caller group, and switching control identification data associated with predetermined ring tone parameters. During activation of the mobile terminal, the mobile terminal establishes a communications link with a communications network. When caller data associated with an incoming call received by the mobile terminal matches the pre-stored caller identification data while, upon termination of the incoming call, the characteristics of ring tones generated by the incoming call match one of the predetermined ring tone parameters, the switch device is switched to a desired mode in response to a control signal outputted by the mobile terminal and associated with the switching control identification data that corresponds to the matching predetermined ring tone parameter.

### CROSS-REFERENCE TO RELATED APPLICATION

This application claims priority of Taiwanese Application No. 091125148, filed on Oct. 25, 2002.

### BACKGROUND OF THE INVENTION

1. Field of the Invention

The invention relates to the control of a switch device, more particularly to a method of controlling a switch device using a mobile terminal in a wireless communications network.

2. Description of the Related Art Recently, it is possible to control a switch device using a mobile terminal, such as a mobile phone, in a wireless communications network, such as a public land mobile phone network (PLMN). It is noted that the switch device can be controlled by a control signal generated by the mobile terminal and associated with an incoming call after the mobile terminal answers the incoming call, thereby resulting in additional communications fees and waste of network resources.

### SUMMARY OF THE INVENTION

Therefore, the object of the present invention is to provide a method of controlling a switch device using a mobile terminal in a wireless communications network which can overcome the drawbacks associated with the aforesaid prior art.

According to one aspect of the present invention, there is provided a method of controlling a switch device using a mobile terminal in a wireless communications network. The method comprises the steps of:

(a) allowing the owner of the mobile terminal to store caller identification data which includes a set of call numbers that are associated with an authorized caller group, and switching control identification data that are associated with predetermined ring tone parameters in a memory unit of the mobile terminal;

(b) during activation of the mobile terminal, allowing the mobile terminal to establish a communications link with the communications network;

(c) upon establishing the communications link with the communications network, verifying whether caller data that is associated with an incoming call received by the mobile terminal matches the caller identification data stored in the memory unit of the mobile terminal and associated with the authorized caller group;

(d) when a match is detected, verifying, upon termination of the incoming call, whether the characteristics of ring tones generated by the incoming call match one of the predetermined ring tone parameters; and

(e) when a match between ring tone characteristics and the predetermined ring tone parameters is detected, enabling the mobile terminal to output a control signal associated with the switching control identification data that corresponds to said matching one of the predetermined ring tone parameters to the switch device so as to enable the switch device to switch to a desired mode in response to the control signal.

According to another aspect of the present invention, there is provided a computer program product for a mobile terminal that communicates wirelessly with a communications network. The mobile terminal includes a user input unit, a memory unit, and a processor unit coupled to the user input unit, the memory unit and a switch device. The computer program product resides in the memory unit and enables the mobile terminal to control the switch device. The computer program product comprises:

a first code that directs the processor unit to allow the owner of the mobile terminal to store caller identification data which includes a set of call numbers that are associated with an authorized caller group, and switching control identification data that are associated with predetermined ring tone parameters in the memory unit of the mobile terminal;

a second code that directs the processor unit to allow the mobile terminal to establish a communications link with the communications network;

a third code that directs the processor unit to verify whether caller data that is associated with an incoming call received by the mobile terminal matches the caller identification data stored in the memory unit of the mobile terminal and associated with the authorized caller group when the communications link with the communications network is established;

a fourth code that directs the processor unit to verify, upon termination of the incoming call, whether the characteristics of ring tones generated by the incoming call match one of the predetermined ring tone parameters when a match is detected; and

a fifth code that directs the processor unit to output a control signal associated with the switching control identification data that corresponds to said matching one of the predetermined ring tone parameters to the switch device so as to enable the switch device to switch to a desired mode in response to the control signal when a match is detected.

According to a further aspect of the present invention, a control terminal is capable of wireless communication with a communications network for controlling a switch device, and comprises:

a radio frequency module;

a memory unit;

means for allowing the owner of the control terminal to store caller identification data which includes a set of call numbers that are associated with an authorized caller group, and switching control identification data that are associated with the predetermined ring tone parameters in the memory unit;

means for allowing the control terminal to establish a communications link with the communications network via the radio frequency module during activation of the control terminal;

means for verifying whether caller data that is associated with an incoming call received by the control terminal matches the caller identification data stored in the memory unit and associated with the authorized caller group upon establishing the communications link with the communications network;

means for verifying, upon termination of the incoming call, whether the characteristics of ring tones generated by the incoming call match one of the predetermined ring tone parameters when a match is detected; and

means for outputting a control signal associated with the switching control identification data that corresponds to the matching one of the predetermined ring tone parameters to the switch device so as to enable the switch device to switch to a desired mode in response to the control signal when a match is detected.

According to still another aspect of the present invention, a control terminal is capable of wireless communication with a communications network for controlling a switch device, and comprises:

a user input unit;

a memory unit;

a radio frequency module;

a processor unit coupled to the user input unit, the memory unit and the radio frequency module and adapted to be coupled to the switch device; and

a computer program product resident in the memory unit for enabling the control terminal to control the switch device, the computer program product including

a first code that directs the processor unit to allow the owner of the control terminal to store caller identification data which includes a set of call numbers that are associated with an authorized caller group, and switching control identification data that are associated with predetermined ring tone parameters in the memory unit;

a second code that directs the processor unit to allow the control terminal to establish a communications link with the communications network via the radio frequency module;

a third code that directs the processor unit to verify whether caller data that is associated with an incoming call received by the control terminal matches the caller identification data stored in the memory unit and associated with the authorized caller group when the communications link with the communications network is established;

a fourth code that directs the processor unit to verify, upon termination of the incoming call, whether the characteristics of ring tones generated by the incoming call match one of the predetermined ring tone parameters when a match is detected; and

a fifth code that directs the processor unit to output a control signal associated with the switching control identification data that corresponds to the matching one of the predetermined ring tone parameters to the switch device so as to enable the switch device to switch to a desired mode in response to the control signal when a match is detected.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic electrical circuit block diagram illustrating a mobile terminal that is configured according to the preferred embodiment of a method of controlling a switch device using the mobile terminal of the present invention; and

FIGS. 2A and 2B are flow charts illustrating how the mobile terminal is configured to control the switch device in accordance with the method of the preferred embodiment.

### DETAILED DESCRIPTION OF THE PREFERRED EMBODIMENT

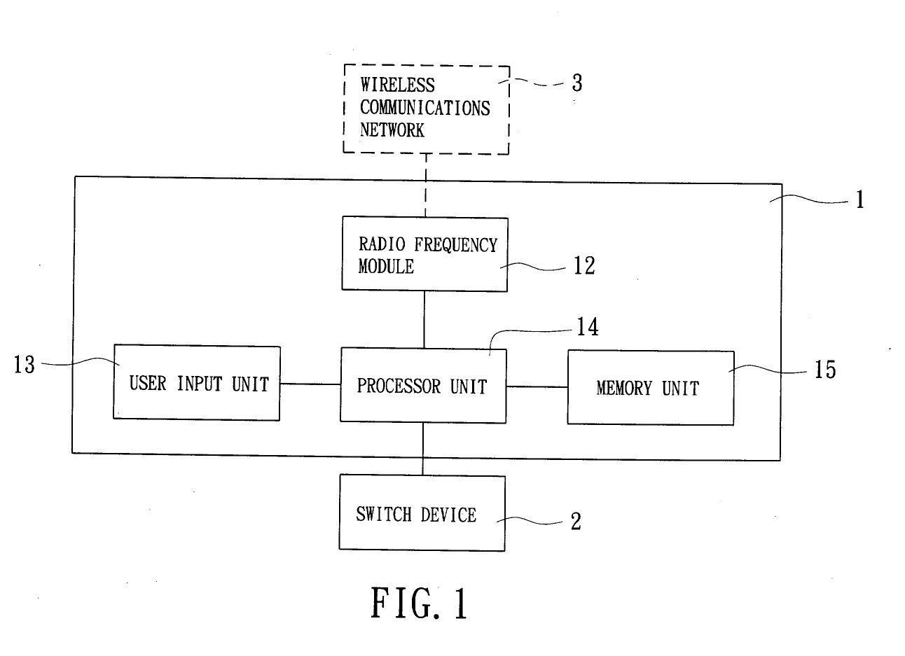

FIG. 1 illustrates a mobile terminal 1, such as a mobile phone, that is configured to operate as a control terminal according to the preferred embodiment of a method of controlling a switch device 2 using the mobile terminal 1 in a wireless communications network 3, such as a public land mobile phone network (PLMN). The mobile terminal 1 includes a radio frequency module 12, a user input unit 13, a memory unit 15, and a processor unit 14 coupled to the radio frequency module 12, the user input unit 13 and the memory unit 15, and the switch device 2. The mobile terminal 1 further includes a computer program product which, in this embodiment, is resident in the memory unit 15.

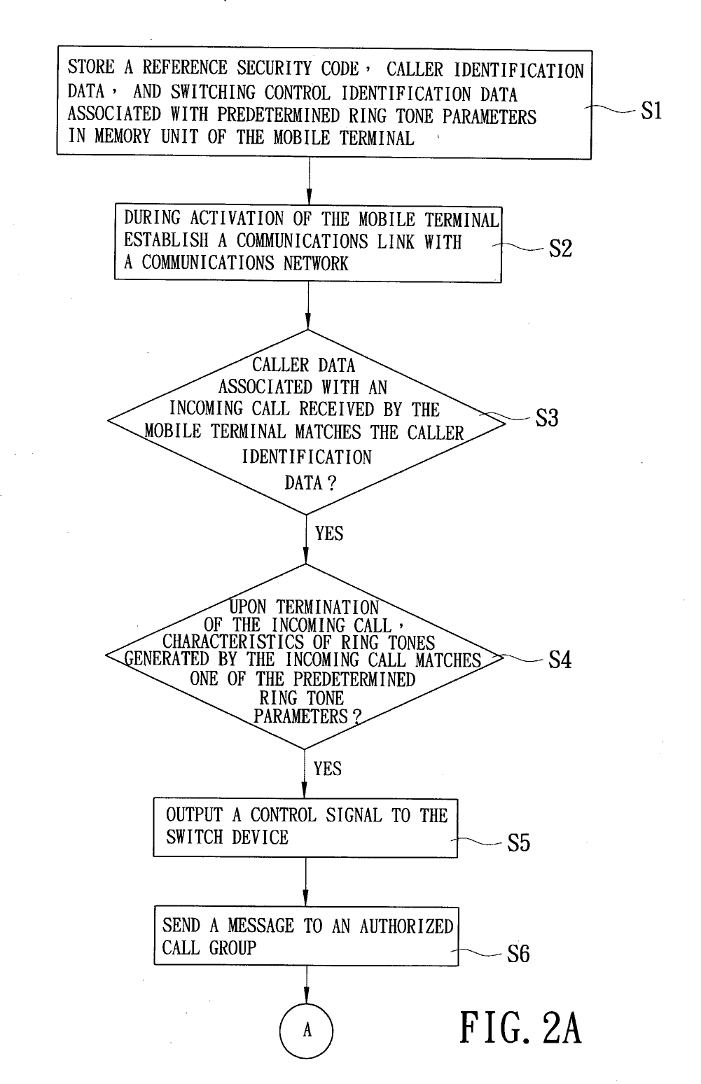

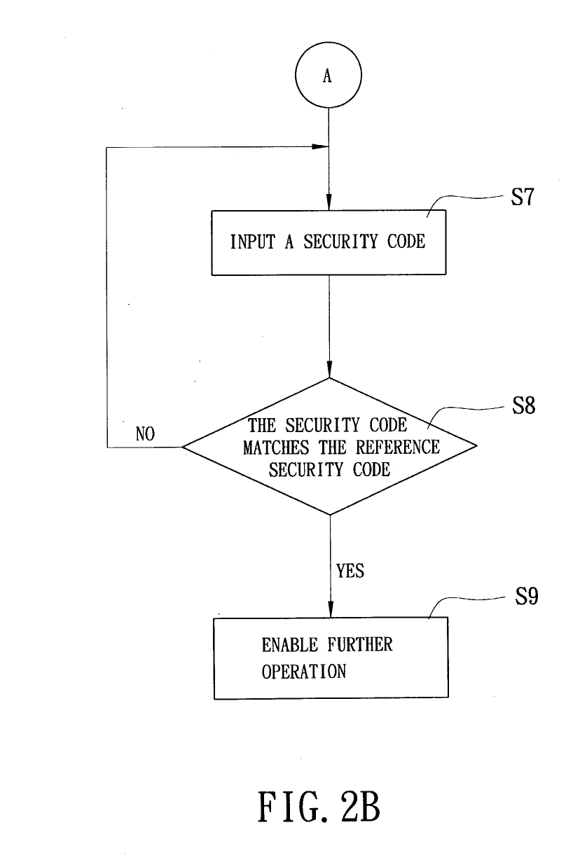

Referring to FIGS. 2A and 2B, flow charts are shown to illustrate how the mobile terminal 1 is configured to control the switch device 2 in accordance with the method of the preferred embodiment. In step S1, a first code of the computer program product configures the processor unit 14 to allow the owner of the mobile terminal 1 to store caller identification data and switching control identification data in the memory unit 15 of the mobile terminal 1. The caller identification data includes a set of call numbers, such as international subscriber identification codes, which are associated with an authorized caller group that is set via the user input unit 13. The switching control identification data are associated with predetermined ring tone parameters, such as the number or duration of ring tones. In this embodiment, the owner of the mobile terminal 1 is further allowed to store a reference security code in the memory unit 15. In step S2, a second code of the computer program product configures the processor unit 14 to allow the mobile terminal 1 to establish a communications link with the communications network 3 via the radio frequency module 12 during activation of the mobile terminal 1. In step S3, a third code of the computer program product configures the processor unit 14 to verify whether caller data that is associated with an incoming call received by the mobile terminal 1 matches the caller identification data stored in the memory unit 15 of the mobile terminal 1 and associated with the authorized caller group when the communications link with the communications network 3 is established. In step S4, when a match is detected, a fourth code of the computer program product configures the processor unit 14 to verify whether the characteristics of ring tones generated by the incoming call matches one of the predetermined ring tone parameters upon termination of the incoming call. In step S5, when a match between ring tone characteristics and the predetermined ring tone parameters is detected, a fifth code of the computer program product configures the processor unit 14 to output a control signal associated with the switching control identification data that corresponds to said matching one of the predetermined ring tone parameters to the switch device 2 so as to enable the switch device 2 to switch to a desired mode in response to the control signal. In step S6, a sixth code of the computer program product configures the processor unit 14 to enable the mobile terminal 1 to send a message to the authorized caller group through the communications network 3. The message indicates a present mode of the switch device 2. In this embodiment, the message may have a format that complies with the conventional short message service, and may include caller identification information, i.e. the call number of the incoming call, and the time at which the incoming call was received by the mobile terminal 1. Alternatively, the message may be in the form of ring tones. In step S7, the computer program product configures the processor unit 14 to allow the user of the mobile terminal 1 to input a security code. In step S8, the computer program product configures the processor unit 14 to verify whether the security code matches the reference security code stored in the memory unit 15. In step S9, when the security code matches the reference security code, the computer program product configures the processor unit 14 to enable further operation of the mobile terminal 1, such as setting, changing, searching or deleting of one of the reference security code, the caller identification data and the switching control identification data.

Therefore, according to the method of the present invention, when the characteristics of ring tones generated by an incoming call that belongs to the authorized caller group matches one of the predetermined ring tone parameters upon termination of the incoming call, the switch device 2 can be switched to a desired mode according to a control signal outputted by the mobile terminal 1 and corresponding to said matching one of the predetermined ring tone parameters. As such, the mobile terminal 1 need not answer the incoming call for controlling the switch device 2 such that communications fees can be reduced to a minimum. Moreover, since the caller data associated with the incoming call and the characteristics of ring tones generated by the incoming call can be obtained within a short time period, waste of network resources can be avoided.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

we claim:

1. A method of controlling a switch device using a mobile terminal in a wireless communications network, said method comprising the steps of:
(a) allowing the owner of the mobile terminal to store caller identification data which includes a set of call numbers that are associated with an authorized caller group, and switching control identification data that are associated with predetermined ring tone parameters in a memory unit of the mobile terminal;
(b) during activation of the mobile terminal, allowing the mobile terminal to establish a communications link with the communications network;
(c) upon establishing the communications link with the communications network, verifying whether caller data that is associated with an incoming call received by the mobile terminal matches the caller identification data stored in the memory unit of the mobile terminal and associated with the authorized caller group;
(d) when a match is detected, verifying, upon termination of the incoming call, whether the characteristics of ring tones generated by the incoming call match one of the predetermined ring tone parameters; and
(e) when a match between ring tone characteristics and the predetermined ring tone parameters is detected, enabling the mobile terminal to output a control signal associated with the switching control identification data that corresponds to said matching one of the predetermined ring tone parameters to the switch device so as to enable the switch device to switch to a desired mode in response to the control signal.

2. The method as claimed in claim 1, further comprising the step of:
(f) enabling the mobile terminal to send a message to the authorized caller group through the communications network, the message indicating a present mode of the switch device.

3. The method as claimed in claim 2, wherein:
in step (a), the owner of the mobile terminal is further allowed to store a reference security code in the memory unit of the mobile terminal;
said method further comprising the steps of:
(g) allowing the user of the mobile terminal to input a security code;
(h) verifying whether the security code matches the reference security code; and
(i) enabling further operation of the mobile terminal when the security code matches the reference security code.

4. A computer program product for a mobile terminal that communicates wirelessly with a communications network, the mobile terminal including a user input unit, a memory unit, and a processor unit coupled to the user input unit, the memory unit and a switch device, said computer program product residing in said memory unit and enabling the mobile terminal to control the switch device, said computer program product comprising:
a first code that directs the processor unit to allow the owner of the mobile terminal to store caller identification data which includes a set of call numbers that are associated with an authorized caller group, and switching control identification data that are associated with predetermined ring tone parameters in the memory unit of the mobile terminal;
a second code that directs the processor unit to allow the mobile terminal to establish a communications link with the communications network;
a third code that directs the processor unit to verify whether caller data that is associated with an incoming call received by the mobile terminal matches the caller identification data stored in the memory unit of the mobile terminal and associated with the authorized caller group when the communications link with the communications network is established;
a fourth code that directs the processor unit to verify, upon termination of the incoming call, whether the characteristics of ring tones generated by the incoming call match one of the predetermined ring tone parameters when a match is detected; and
a fifth code that directs the processor unit to output a control signal associated with the switching control identification data that corresponds to said matching one of the predetermined ring tone parameters to the switch device so as to enable the switch device to switch to a desired mode in response to the control signal when a match between ring tone characteristics and the predetermined ring tone parameters is detected.

5. A control terminal capable of wireless communication with a communications network for controlling a switch device, said control terminal comprising:
a radio frequency module;
a memory unit;
means for allowing the owner of said control terminal to store caller identification data which includes a set of call numbers that are associated with an authorized caller group, and switching control identification data that are associated with the predetermined ring tone parameters in said memory unit;
means for allowing said control terminal to establish a communications link with the communications network via said radio frequency module during activation of said control terminal;
means for verifying whether caller data that is associated with an incoming call received by said control terminal matches the caller identification data stored in said memory unit and associated with the authorized caller group upon establishing the communications link with the communications network;
means for verifying, upon termination of the incoming call, whether the characteristics of ring tones generated by the incoming call match one of the predetermined ring tone parameters when a match is detected; and
means for outputting a control signal associated with the switching control identification data that corresponds to said matching one of the predetermined ring tone parameters to the switch device so as to enable the switch device to switch to a desired mode in response to the control signal when a match between ring tone characteristics and the predetermined ring tone parameters is detected.

6. A control terminal capable of wireless communication with a communications network for controlling a switch device, said control terminal comprising:
a user input unit;
a memory unit;
a radio frequency module;
a processor unit coupled to said user input unit, said memory unit and said radio frequency module and adapted to be coupled to the switch device; and
a computer program product resident in said memory unit for enabling said control terminal to control the switch device, said computer program product including
a first code that directs said processor unit to allow the owner of said control terminal to store caller identification data which includes a set of call numbers that are associated with an authorized caller group, and switching control identification data that are associated with predetermined ring tone parameters in said memory unit;
a second code that directs said processor unit to allow said control terminal to establish a communications link with the communications network via said radio frequency module;
a third code that directs said processor unit to verify whether caller data that is associated with an incoming call received by said control terminal matches the caller identification data stored in said memory unit and associated with the authorized caller group when the communications link with the communications network is established;
a fourth code that directs said processor unit to verify, upon termination of the incoming call, whether the characteristics of ring tones generated by the incoming call match one of the predetermined ring tone parameters when a match is detected; and
a fifth code that directs said processor unit to output a control signal associated with the switching control identification data that corresponds to said matching one of the predetermined ring tone parameters to the switch device so as to enable the switch device to switch to a desired mode in response to the control signal when a match between ring tone characteristics and the predetermined ring tone parameters is detected.
